(19) United States
(12) Patent Application Publication
(10) Pub. No.: US 2005/0140496 A1
(43) Pub. Date: Jun. 30, 2005

(54) Keypad and method for electronic access security and keyless entry of a vehicle

(75) Inventors: Dave Magner, Calmar, IA (US); Rick McIntosh, Altoona, IA (US); Julie M. Houdek, New Hampton, IA (US); Anita L. Reichling, New Hampton, IA (US)

Correspondence Address: MCKEE, VOORHEES & SEASE, P.L.C., 801 GRAND AVENUE, SUITE 3200, DES MOINES, IA, 50309-2721, US

(73) Assignee: TRIMARK CORPORATION, New Hampton, IA (US)

(21) Appl. No.: 11/065,815

(22) Filed: Feb. 25, 2005

Related U.S. Application Data
(63) Continuation-in-part of application No. 10/213,409, filed on Aug. 6, 2002.

(51) Int. Cl. G06F 7/04

(52) U.S. Cl. 340/5.54; 340/5.72

(57) ABSTRACT

A keypad for a vehicle system includes a housing having a front side, a back side, and side members, the front side having a flange adapted for mounting to a vehicle. A plurality of buttons are operatively connected to the housing and recessed in the front side, each of the plurality of buttons being press resistant to provide tactile feedback. At least one lighting device is associated with each of the plurality of buttons and operatively connected to the housing for providing visual feedback.

### RELATED APPLICATIONS

This application is a continuation-in-part of and claims priority to U.S. patent application Ser. No. 10/213,409 filed on Aug. 6, 2002, hereby incorporated by reference in its entirety.

### BACKGROUND OF THE INVENTION

This invention relates to a use of a keypad for providing secured access to a vehicle and controlling of vehicle functions using the keypad.

There have been some attempts to provide for secured access through a keypad associated with a door, although there has been more interest in providing remote keyfob transmitters. One example of a system using a keypad is disclosed in U.S. Pat. No. 5,278,547 to Suman et al. In Suman, a keypad is directly connected to a microcontroller that controls vehicle functions. There are problems that relate connecting all vehicle inputs (including a keypad) and all vehicle outputs to a single microcontroller. In particular, the amount of wiring that needs to be performed is expensive, makes repairs more difficult and costly, and makes it more difficult to customize. The method of customization shown in the prior art is to prewire the vehicle harness and then choose which features to include. This results in the vehicle harness being prewired for all features. This would allow all vehicles, regardless of options installed, to use the same wiring harness but also limits the options available.

These problems are particularly apparent as they relate to the manufacture of non-automotive vehicles. Many such vehicles are far more complicated than cars. For example, recreational vehicles (RVs), trucks, specialty vehicles, emergency vehicles, construction equipment, agricultural equipment and other types of vehicles may be large in nature and have numerous features or amenities that it would be useful and desirable to control via one or more keypads. These types of vehicles may have multiple entry doors, multiple compartments on the inside or outside of the vehicles, gas compartment doors, maintenance doors, various lighting fixtures on the inside or outside of the vehicle, and numerous other functions some of which may be highly specialized. These vehicles are more likely to need greater customization in the placement of one or more keypads and in the vehicle functions controlled by each keypad.

Another problem related to these types of vehicles is that there is a need to control a greater number of vehicle functions than are typically controlled in an automotive keypad access system. Thus the systems generally associated with automotive vehicles are not appropriate in vehicles such as recreational vehicles (RVs), trucks, specialty vehicles, emergency vehicles, construction equipment, agricultural equipment, and similar types of vehicles.

Therefore, it is a primary object, feature, or advantage of the present invention to improve upon the state of the art.

It is a further object, feature, or advantage of the present invention to provide a modular solution for keypad control of a vehicle.

Another object, feature, or advantage of the present invention is to provide a keypad module that does not require redesign of the vehicle's wiring harness.

Yet another object, feature, or advantage of the present invention is to provide a keypad module that provides for network communication with other aspects of the vehicle.

It is a further object, feature, or advantage of the present invention to provide a keypad that can control vehicle functions that include more than merely an entry door.

It is a still further object, feature, or advantage of the present invention to provide a keypad that can be placed in any number of customizable positions on a vehicle.

Another object, feature, or advantage of the present invention is to provide a keypad that is versatile in the manner in which it is mounted to the vehicle.

A further object, feature, or advantage of the present invention is to provide a keypad that provides for tactile feedback when a key or button is pressed.

A still further object, feature, or advantage of the present invention is to provide a keypad that provides for audio feedback in response to buttons being pressed, codes being entered, and other conditions.

Another object, feature, or advantage of the present invention is to provide a keypad that provides for visual feedback in response to buttons being pressed, codes being entered, and other conditions.

One or more of these and/or other objects, features, and/or advantages of the present invention will become apparent from the specification and claims that follow.

### SUMMARY OF THE INVENTION

According to one aspect of the invention, a keypad for a vehicle entry system is provided. The keypad includes a housing having a front side, a back side, and side members, the front side having a flange adapted for mounting to a vehicle. There are a plurality of buttons operatively connected to the housing and recessed in the front side, each of the plurality of buttons being press resistant to provide tactile feedback. There is at least one lighting device associated with each of the plurality of buttons and operatively connected to the housing for providing visual feedback. The plurality of buttons are operatively connected to an intelligent control such as a microcontroller. The intelligent control can be located within the keypad's housing or else wired to the keypad. The intelligent control is adapted to provide an audio alert for various conditions, such as each press of the plurality of buttons or the entry of a correct or incorrect code. The keypad is used to enter an access code. The access code is verified by the intelligent control. Entry of a proper access code enables control of vehicle functions permitted by the access code. After the access code is properly entered, the operator can enter codes to control vehicle functions.

According to another aspect of the invention a method of using a keypad access and control system is provided. The method includes providing a keypad having a housing having a front side, a back side, and side members, the front side having a flange adapted for mounting to a vehicle. The keypad also has a plurality of buttons operatively connected to the housing and recessed in the front side. The keypad further includes at least one lighting device associated with each of the plurality of buttons and operatively connected to the housing for providing visual feedback. The method further includes receiving an access code from the plurality of buttons and receiving a code associated with at least one vehicle function, the code enabled by the access code. The method allows for controlling the at least one vehicle function through entering of the code.

### BRIEF DESCRIPTION OF THE DRAWINGS

FIG. 1 is a side view of a vehicle equipped with a plurality of keypad modules according to one embodiment of the present invention.

FIG. 2 is a front view of a keypad module in a horizontal orientation according to one embodiment of the present invention.

FIG. 3 is a front view of a keypad module in a vertical orientation according to another embodiment of the present invention.

FIG. 4 is a front perspective view of one embodiment of the keypad module of the present invention.

FIG. 5 is a rear perspective view of one embodiment of the keypad module of the present invention.

FIG. 6 is a block diagram of a keypad module according to one embodiment of the present invention.

FIG. 7A-7F provide schematic diagrams of one embodiment of the keypad module of the present invention.

FIG. 8 is a block diagram showing the keypad module of the present invention within a vehicle system.

FIG. 9 is a block diagram showing the keypad module of the present invention within a vehicle system in a different configuration.

FIG. 10 is an exploded perspective view showing the keypad module with the circuit board, an elastomer layer, and the housing.

FIG. 11 is a block diagram illustrating one embodiment of the present invention where a discrete keypad is used.

FIG. 12 is a block diagram illustrating one embodiment of the present invention where a discrete keypad is used in a different configuration.

FIGS. 13A-13G provide schematic diagrams of one embodiment of the discrete keypad embodiment of the present invention.

### DETAILED DESCRIPTION OF THE INVENTION

The present invention provides for using a keypad in a vehicle control system. The keypad allows a user to enter a security or access code and then once a correct security or access code has been entered, to enter one or more codes to control functions of the vehicle. In one embodiment of the invention the keypad includes an independent intelligent control that communicates over a network with a distributed control module. In another embodiment a discrete keypad is used which communicates via a high/low signal to a centralized control module. The present invention is not, however, to be limited to the specific embodiments described herein, but contemplates numerous variations.

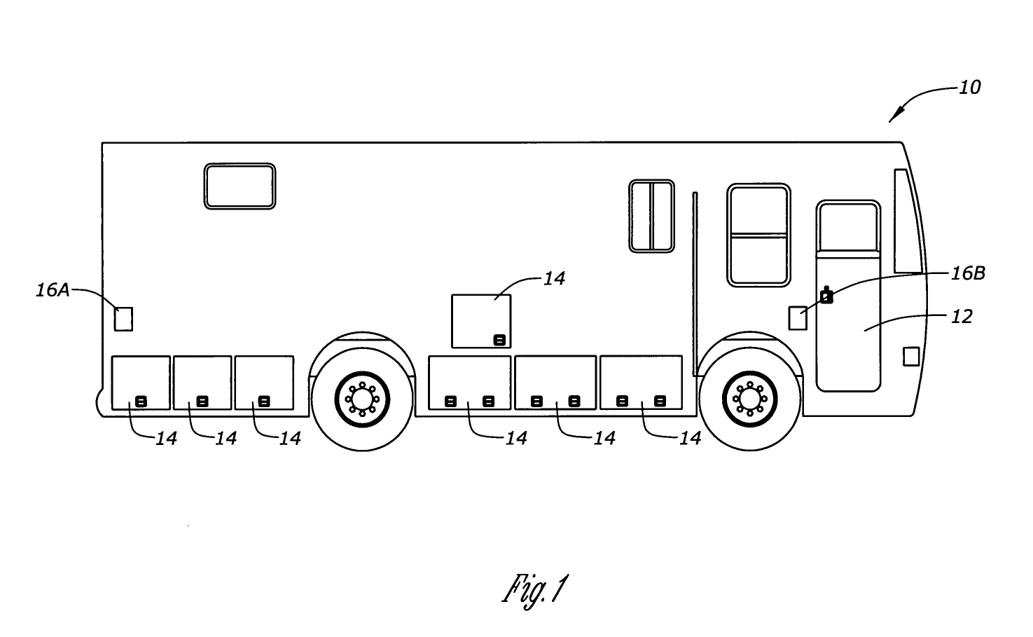

FIG. 1 illustrates a vehicle 10 according to one embodiment of the present invention. The vehicle 10 shown is an RV, however, the present invention is in no way limited for use in an RV. The present invention can be used in numerous applications, including vehicles such as semi-truck tractors, ambulances, construction equipment, agricultural equipment, buses, and other types of vehicles. The present invention also contemplates use on marine equipment and stationary enclosures. The vehicle 10 shown has a passenger door 12 and a number of different compartment doors 14. The compartment doors 14 are spread out along the passenger side of the vehicle 10. Two different keypad modules 16A and 16B are shown. The first keypad module 16A and the second keypad module 16B are located on different ends of the vehicle 10 with the second keypad module 16B being located near the passenger door 12 and the first keypad module 16A being located near the rear most compartment doors 14. An operator of the vehicle 10 can use either the first keypad module 16A or the second keypad module 16B to unlock the passenger door 12 and enter the vehicle 10 or unlock various compartment doors 14, including the rear most doors 14. Addition provisions within the system and vehicle can provide for door actuating or opening. Although only two keypad modules 16A and 16B are shown, the present invention contemplates that numerous keypad modules 16 can be provided. The present invention also contemplates that the keypad modules 16 can be placed in various positions on the vehicle such as may be convenient or desirable.

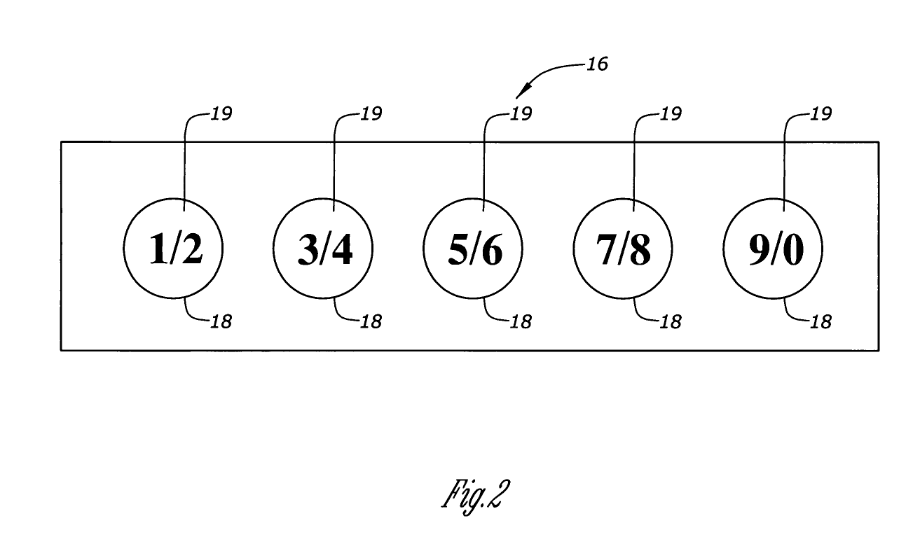

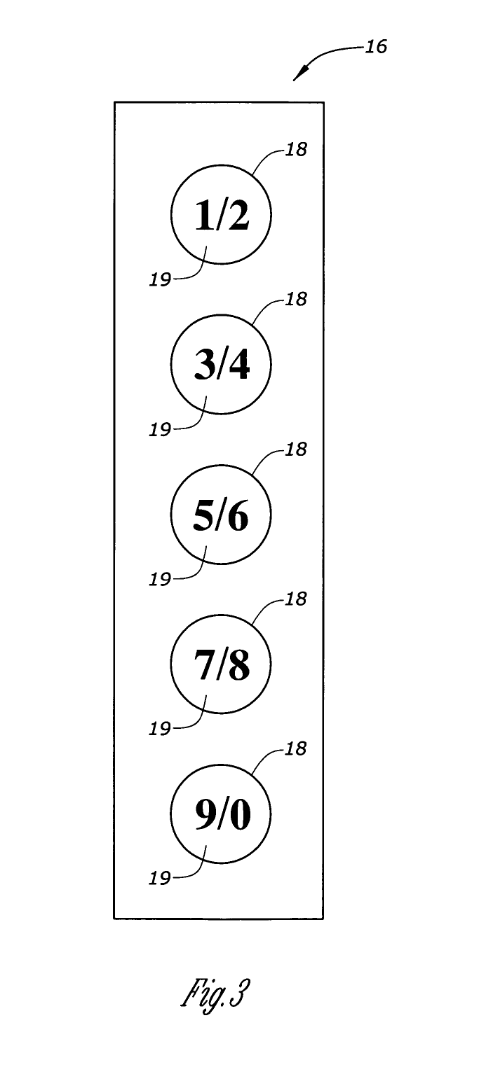

FIG. 2 provides a front view of one embodiment of the keypad module of the present invention. A plurality of buttons 18 are shown. Each of the buttons has a label 19. Preferably, each of the buttons is labeled with a number or numbers for identifying purposes, in order to provide for a convenient and intuitive interface to the vehicle operators, however, the present invention contemplates that other identifiers or no identifiers at all can be used. The keypad module of the present invention is preferably versatile such that it can be mounted in multiple orientations, such as the horizontal orientation shown in FIG. 2 or the vertical orientation shown in FIG. 3.

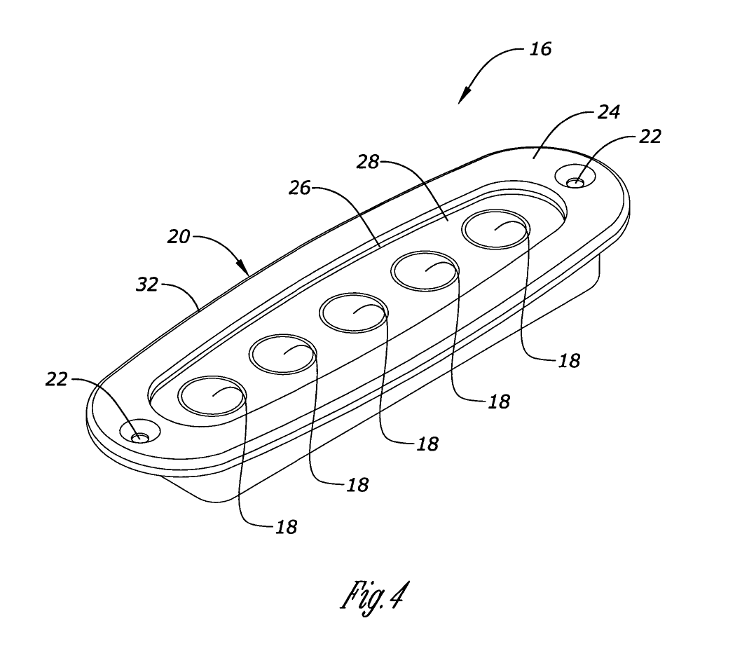

FIG. 4 provides a perspective view of the keypad module 16. The keypad module 16 is adapted for mounting to a vehicle. The keypad module includes a housing 20 having a front side 24. The front side 24 has a flange 32 that is adapted to mounting to a vehicle. As shown, there are apertures 22 on opposite ends of the flange 32 for connecting the keypad module 16 to a vehicle using external fasteners. In addition, the present invention contemplates that rear details, such as externally thread studs, can be used for tamper resistant mounting. The front side 24 also has a recessed portion 28. The buttons 18 are placed within the recessed portion 28. Each of the buttons preferably has pressing resistant features to provide tactile feedback. Also, preferably, each of the buttons is backlit so that it can bee seen in different lighting conditions.

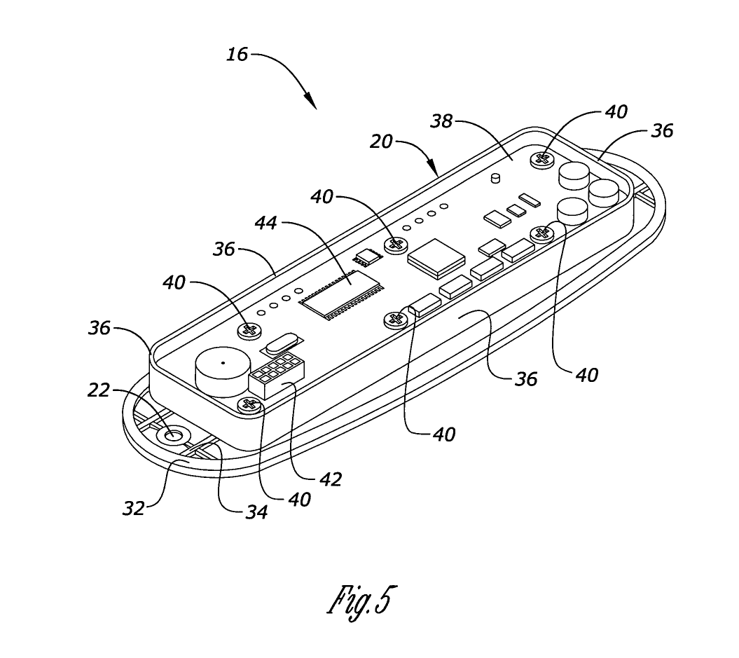

FIG. 5 provides a perspective view of the opposite end of the keypad module 16. The back side 34 of the keypad module 16 includes a plurality of sidewalls 36. A printed circuit board (PCB) 38 is placed within the housing 20. The printed circuit board 38 is operatively connected to the housing 20 with fasteners 40. The printed circuit board 38 includes an intelligent control 44 such as a PIC 16F873 microcontroller available from Microchip Technology, Incorporated. In addition, a connector 42 is shown for connecting the keypad module 16 and power connections to a network.

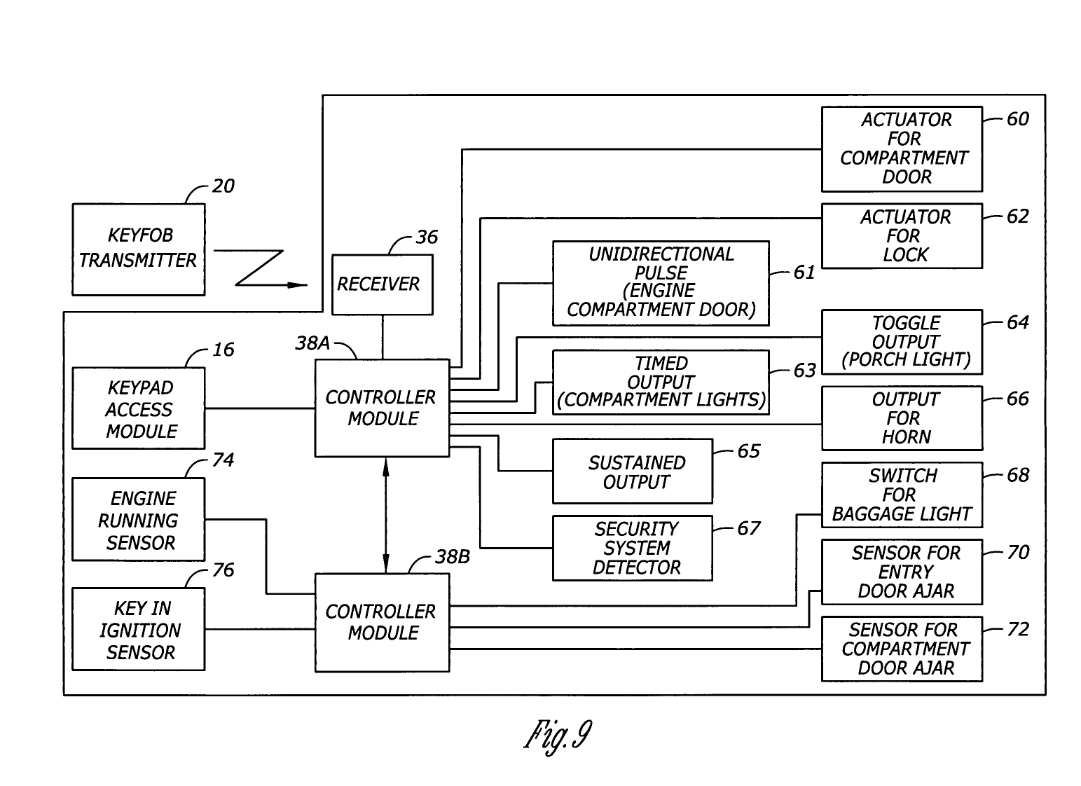

FIG. 10 provides an exploded view of the keypad module 16. In FIG. 10, a sealing member such as an elastomer layer 45 is sandwiched between the circuit board 38 and the housing 20. The present invention provides for improved sealing through use of the elastomer layer 45. The elastomer layer can be silicone based or of other types. Preferably, the elastomer layer 45 includes ridges to improve sealing. The elastomer layer 45 can also include a protective coating for further increasing durability and chemical resistively of the keypad module 16.

The circuit board is preferably covered with a silicone, epoxy, or other sealing compound 47. The sealing compound provides rigidity as well as sealing. Preferably, the sealing compound is at least approximately ¼ inches in thickness, however, the present invention contemplates that lesser thicknesses can be used. The sealing compound can also be used to seal the connections of cables exiting from the keypad module 16 to further protect the circuit board 38 from the environment or contaminants.

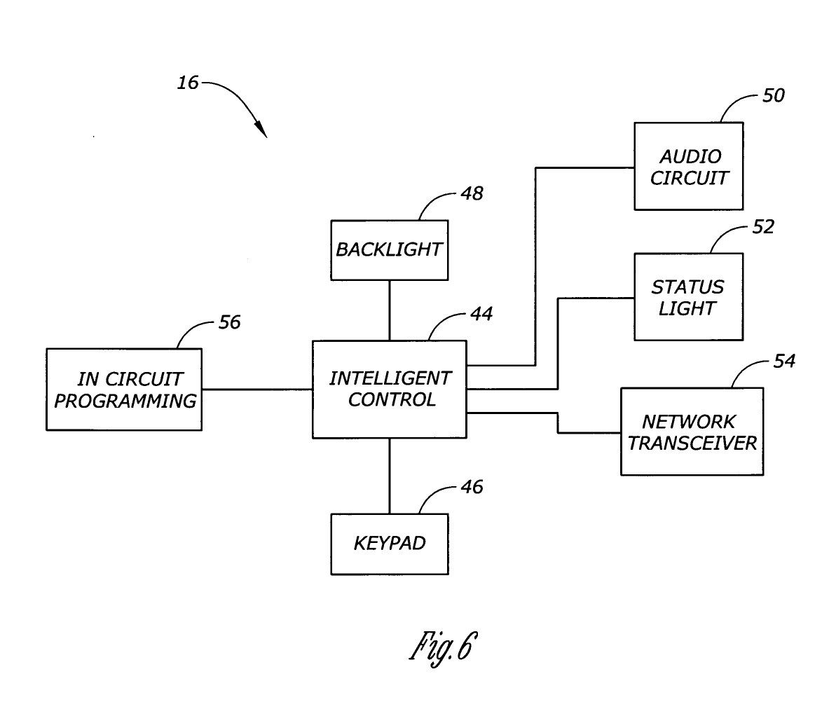

FIG. 6 provides a block diagram of the electronics of the keypad module 16 according to one embodiment of the present invention. The intelligent control 44 is electrically connected to the keypad 46 that includes a plurality of buttons or keys. The intelligent control 44 is also electrically connected to a backlight circuit 48 associated with the keypad 46. Preferably the intelligent control 44 provides pulse width modulation brightness/power control of the backlight circuit 48 that can include one or more lighting devices. Also, preferably, the intelligent control 44 provides power management features for the keypad backlights. The power management features include means to automatically deactivate backlighting after a duration of time with no button pressing or when vehicle power supply voltage is drained to a predetermined threshold amount. The presence or absence of backlighting or the intensity of lighting can be used to provide visual feedback of the pressing of a button associated with the keypad 46.

An audio circuit 50 that can contain a buzzer is also electrically connected to the intelligent control 44. The audio circuit 50 can be used to provide audio feedback to indicate that one or more buttons associated with the keypad 46 have been pressed. Because the audio circuit is controlled by the intelligent control 44, the present invention contemplates numerous variations in the use of audio feedback. For example, audio feedback can be used to indicate that a single button on keypad 46 has been pressed, such as through use of a single chirp. In addition, audio feedback can be used to indicate that a correct access code has been entered through the use of multiple chirps. The present invention further contemplates that audio feedback can be used for other purposes including entry of incorrect code or to indicate error conditions.

The backlight circuit 48 or separate status lights 52 can also be electrically connected to the intelligent control 44. The backlight circuit 48 or separate status lights 52 can be used to indicate error conditions of other aspects of the status of the keypad module 16. In one embodiment of the present invention, each time one of the buttons of the keypad 46 is pressed, a corresponding light is flashed.

A network transceiver 54 is also electrically connected to the intelligent control 44. Preferably the network transceiver 54 uses a standard RS-485 transceiver. The network preferably uses the physical layer of the J 1708 standard that has low electromagnetic interference (EMI) characteristics. The network preferably supports at least 20 nodes at a baud rate of 9600. It is preferred that cabling to other devices on the network uses at least 18 gauge wire, twisted at 1 turn per inch. The operational cable limit then becomes approximately 130 feet.

Preferably, an in-circuit programming circuit 56 is also electrically connected to the intelligent control 44. This allows the intelligent control to be programmed without removing the intelligent control 44 from the sealed keypad housing. Thus updates to the programming can be made conveniently and inexpensively.

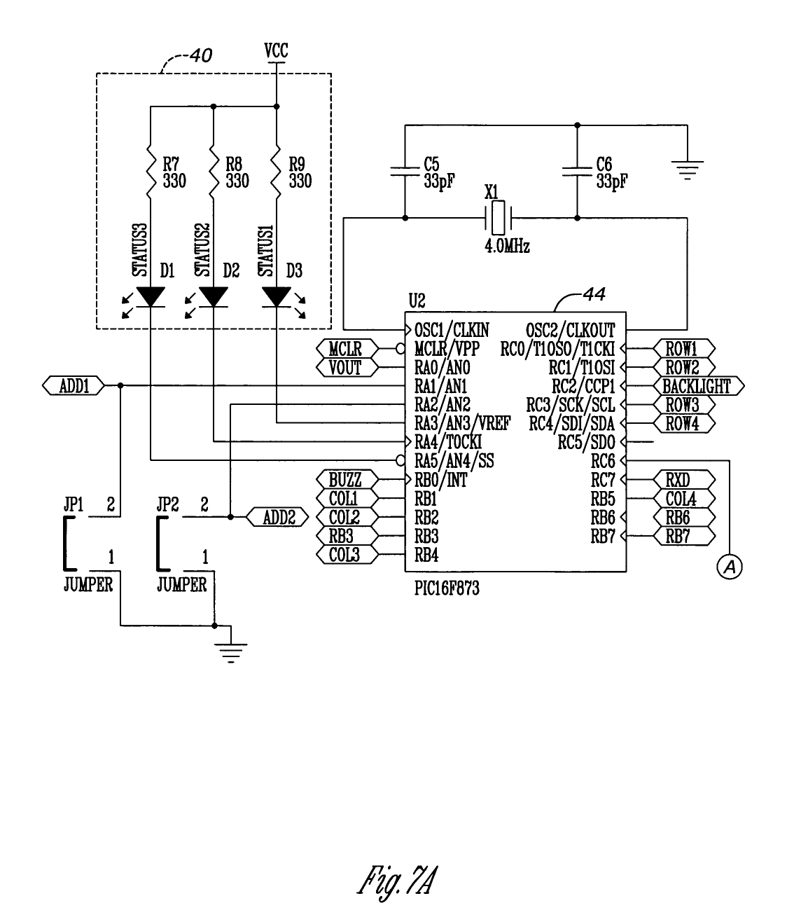

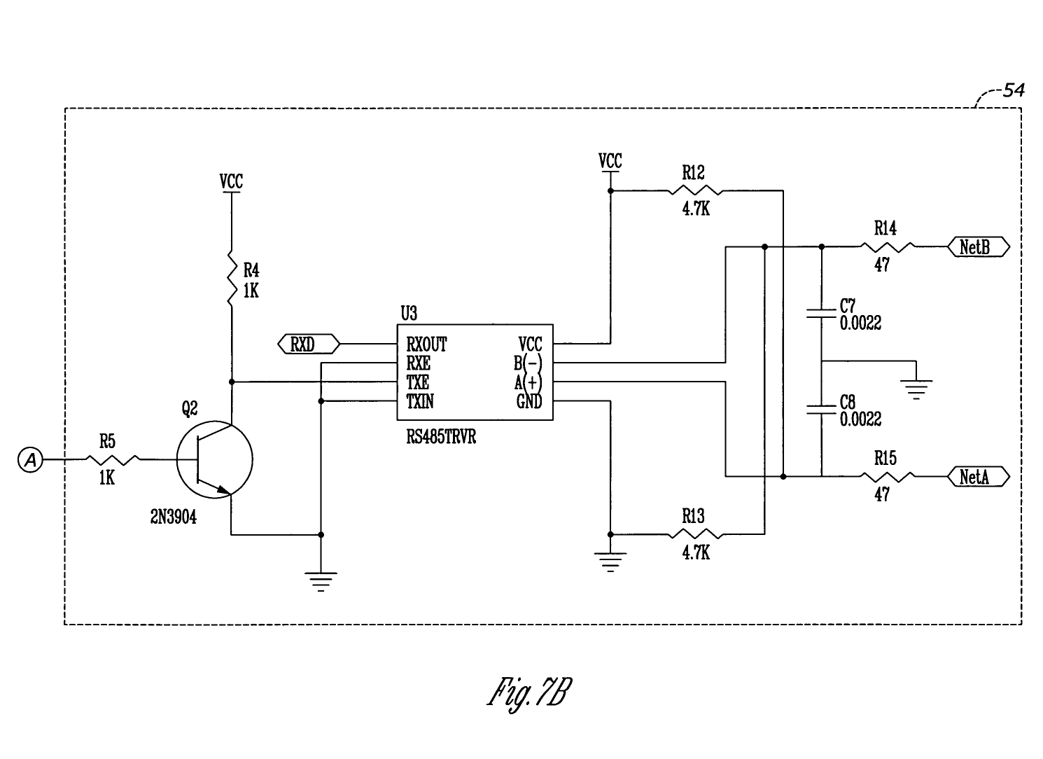

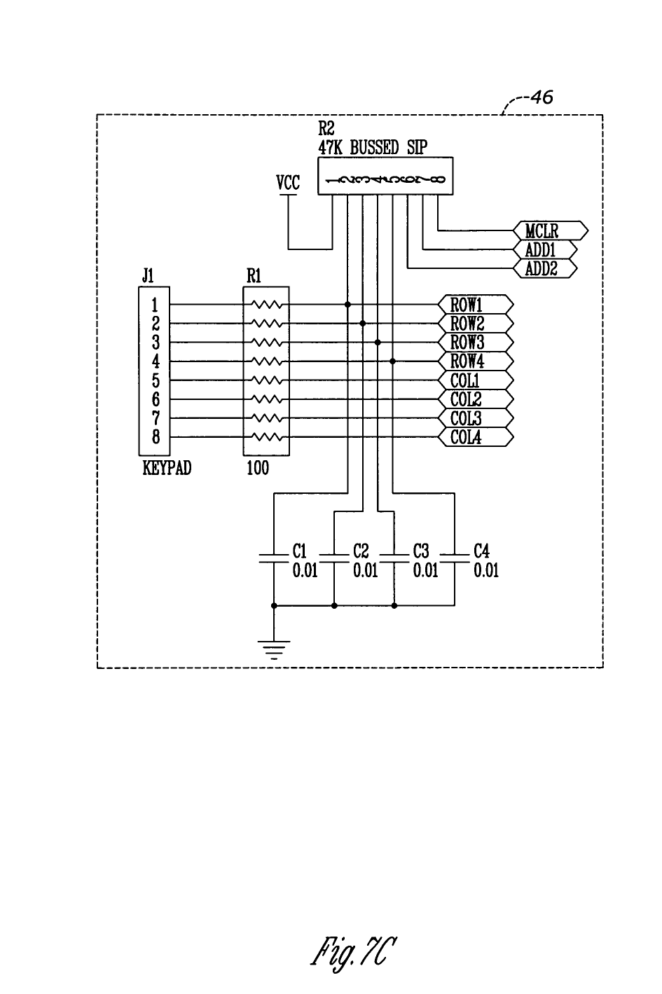

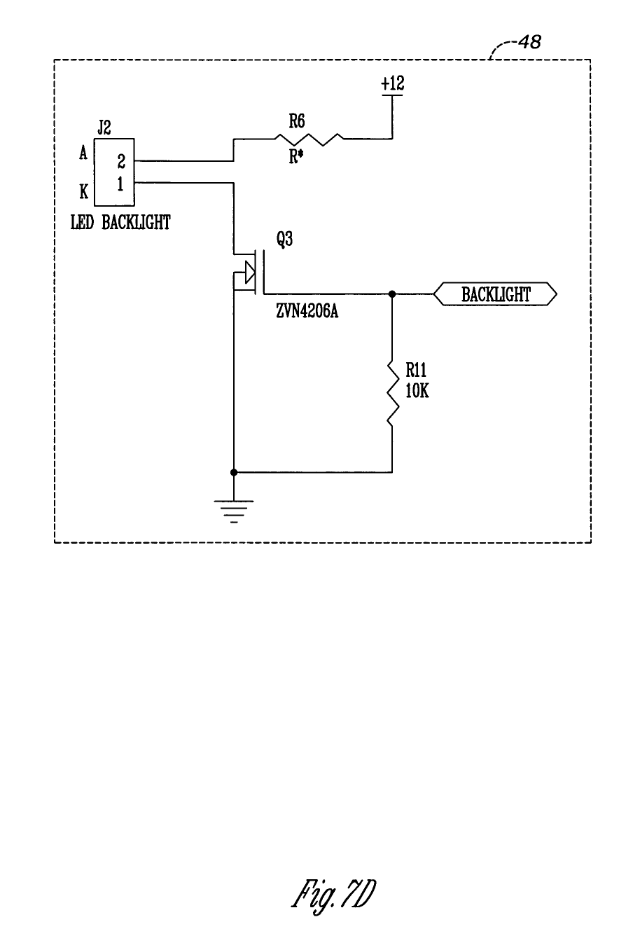

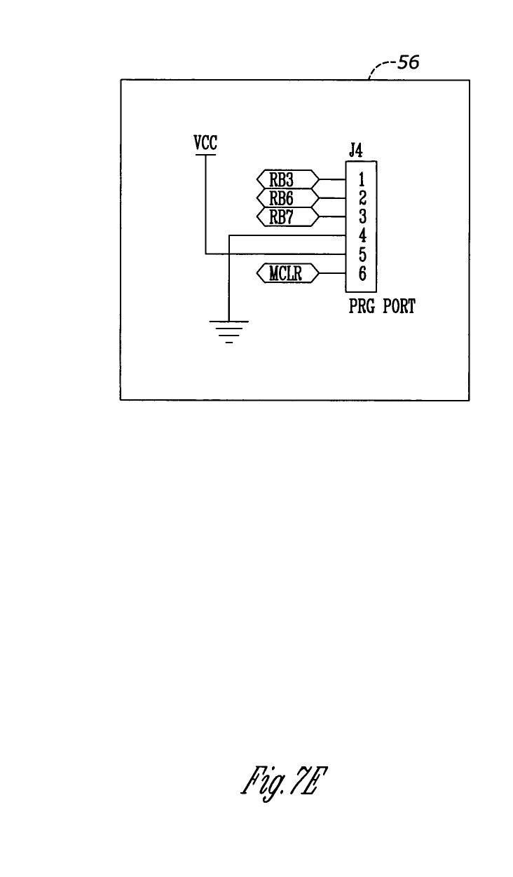

FIGS. 7A-7F provide more detailed electrical schematics of the keypad module of the present invention. In FIG. 7A, the intelligent control 44 is shown electrically connected to the status lights 52. In FIG. 7B the network transceiver 54 is shown. FIG. 7C illustrates the keypad circuit 46. FIG. 7D illustrates a lighting device backlight circuit 48. FIG. 7E illustrates an in-circuit programming circuit 50. FIG. 7F illustrates an audio circuit 50 with a buzzer, although other types of audio circuits can be used where appropriate.

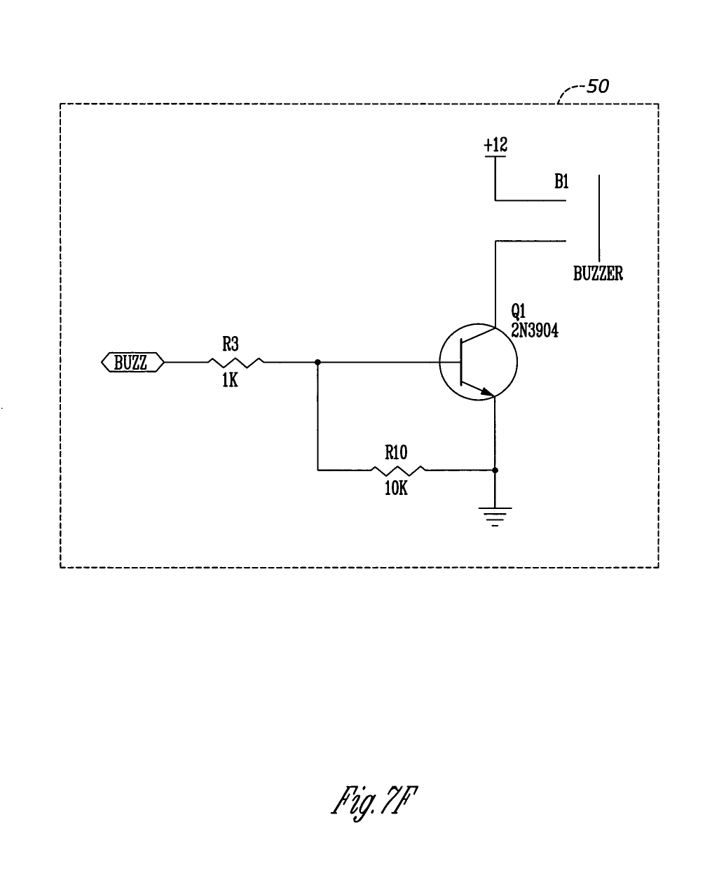

FIG. 8 provides a block diagram showing one embodiment of the relationship of the keypad module of the present invention to other aspects of the vehicle. The system 100 includes a key fob transmitter unit 102 and a vehicle subsystem 104. The vehicle subsystem 104 includes a receiver 106 in communication with the key fob transmitter 102. The key fob transmitter 102 communicates with the receiver 106 through RF communications or otherwise. The receiver 106 is electrically connected to a control module 108. A control module 108 is also connected to one or more keypad modules 16A and 16B. Each of the keypad modules 16A and 16B and the control module are electrically connected together over a network. The control module 108 is used to control a plurality of zones. A zone is a grouping of actuators or other electronic switches associated with a vehicle and vehicle functions. For example, various switches can be used to control lighting, various actuators can be used to control locking and unlocking compartment doors or entry doors, unlocking or opening doors, or other vehicle functions. For illustrative purposes, a first zone 110 is shown containing both a switch 112 and an actuator 114. A second zone 116 is shown containing both a switch 118 and an actuator 120. A third zone 122 is shown containing an actuator 124 and a fourth zone 126 is shown containing a switch 128. The present invention contemplates numerous zones and within each zone the present invention contemplates that any number of electronic switches and/or actuators and/or other vehicle controls may be used. Entering a security code from the keypad module 16 or entering a single command from the keypad module can then control multiple vehicle functions, such as unlocking all compartment doors within a particular zone, or unlocking all entry doors within a particular zone. The following table sets forth some examples of vehicle functions that can be associated with an input:

| | | # of |
|---|---|---|
| Connection | Vehicle function | inputs |
| 1 | Lock all or lock designated | 1 |
| | door zone | |
| 2 | Unlock all or Unlock | 1 |
| | designate zone | |
| 3 | Additional indepented | 1 |
| | Locking function (e.g | |
| | Lock compartments) | |
| 4 | Additional independent | 1 |
| | Unlocking function (e.g. | |
| | Unlock compartments | |
| 5 | Additional Locking | 1 |
| | function for other assigned | |
| | door zones | |
| 6 | Additional Unlocking | 1 |
| | function for other assigned | |
| | door zones | |
| 7 | Unidirectional pulse (e.g | 1 or |
| | engine compartment door | more |
| | open puls) | |
| 8 | Toggle output (e.g porch | 1 or |
| | light) | more |
| 9 | Timed output (e,g. | 1 or |
| | compartment lights) | more |
| 10 | Sustained Output | 1 or |
| | | more |
| 11 | Security System Detectors | 1 or |
| | | more |

Each of the keypad modules 16A and 16B can be associated with any number of vehicle functions. The present invention contemplates that upon entering a security code, preferably a five digit security code into the keypad module 16A, that entry doors or compartment doors can be unlocked. In addition, the present invention contemplates that once a security code is entered, different keypresses can control different vehicle functions. The present invention allows for the security code to be of any size that is convenient and provides appropriate security for a particular application. For example, a three digit security code is not as secure as a five digit code, but may be more convenient for an operator to remember. In addition, the present invention contemplates that numerous security codes can be used. Each security code can be associated with a particular set of vehicle functions. This allows a first operator having a first security code to have more, less, or different access than a second operator having a second security code different.

The present invention provides for communication between each keypad module 16 and other devices such as control modules 108. This allows any number of keypad modules to be used and any number of control modules or other devices to be used and for all such devices to communicate with one another. Where more than one keypad module is used, the identity of each keypad module can be set with a switch or jumper, set in software, or otherwise assigned.

To provide for network communications, any number of protocols and/or message formats may be used. According to one embodiment a physical layer based on the Society of Automotive Engineers (SAE) J1708 electrical standard is used. This standard provides for serial data communications links. It should be appreciated, however, that the present invention is not limited merely to this protocol but contemplates other types of networks can be used, included CAN (Controller Area Networks) as may be appropriate in a particular application or environment. According to one embodiment of the present invention an AMP connector is used providing a four pin connection for power and network connections. The present invention contemplates numerous variations in the protocol used. According to one embodiment of the present invention, the messages sent begin with an ‘STX’ (02H) character and are transmitted at 2400 baud with 8 data bits and 1 stop bit. Various commands can then be used as may be appropriate in a particular environment or application. The commands can include commands to learn and/or change programming, commands that will change security codes, commands that will lock all doors, commands to unlock a particular zone, commands to unlock all zones, commands to toggle an auxiliary output which may be a sustained output, commands to send a pulse output, commands to change the status (for example to change between a secure mode and an unsecure mode), commands to indicate errors, and commands to issue a wakeup to particular devices. This are merely representative types of commands that may be used. The present invention contemplates any number of commands.

For example, the command to learn or change programming can be a “CP.” This command can be sent by any device. All devices with learning capability will go into their learn mode for their specified time limits when this command is sent.

Another command that can be sent is a change of code command. The change of code command can include the new code as well as a code checksum. Where a five digit code is used, the command string “CA#####$” can be sent to change code A. The present invention contemplates that multiple codes can be used for different keyfob transmitters 102 or keypad modules 16. The “#####” in the command string indicates the code. The “$” in the command string is used as a checksum verification of the code received. It can be calculated by adding the numeric values of the numbers in the code and then taking module 10 of that sum and converting to the ASCII equivalent. For example the code 12345 would be summed to 1+2+3+4+5=15, and mod 10 of that is 5 such that the “$” in the command string could be replaced by “5” in that instance. The present invention contemplates that other sizes of codes can be used and other or no checksums can be used.

A further example of a command is “LA” to lock all. This command can be sent by any device. All devices that can control locks will start the process to lock all doors when this command is sent. The present invention can provide for sequentially actuating locks to avoid the increased current considerations when all locks are simultaneously actuated. Once all of the locks are considered secure, a corresponding secure status message can be sent.

Another example of a command is to unlock a particular zone. For example the command “U1” can be used to unlock zone 1. This command can be sent by any device. Any device that can control zone 1 locks will then unlock zone locks when it receives this command. An unsecure status message can be sent when complete. A similar command to unlock all zones is “UA.” This command can also be sent by any device and can be used to initiate the process of unlocking all doors. When any lock is considered unsecure, a corresponding unsecure status message can be sent.

An auxiliary output toggle command can be sent as “A1” by any device. Any device controlling an auxiliary output 1 can then turn the output on until a timeout occurs (if set) or until toggle off by the same command message or others. Similarly, commands “A2” through “A9” can be used to toggle auxiliary outputs 2-9.

A pulse output command can be sent as “P1” by any device. Any device controlling the corresponding pulsed output 1 can then pulse the output. Similarly, commands “P2” through “P9” can be used to pulse outputs 2-9.

Status messages are sent by control modules and not by every device. A secure mode status message such as “MS” indicates that the vehicle is secure. An unsecure mode status message such as “MU” indicates that the vehicle is not secure. The present invention contemplates that other types of status messages can be used.

The present invention also contemplates that error messages can be used. For example an “EK” can be sent to indicate that there is an error in the keypad module. An “EL” can be sent to indicate that three wrong codes have been entered. An “EC” can be sent to indicate a bad code checksum. Other error codes can be set to indicate other types of errors.

Another type of message that can be sent is a wake up message. One command string that can be used is “WU”. The wake up message can be sent by any device receiving a stimulus from a user or otherwise. The “WU” can be used to cause dome lights to turn or for any number of other vehicle functions.

The present invention contemplates that the keypad module 16 can be used for any number of additional vehicle control commands. The present invention also contemplates that where multiple user codes are used, different vehicle functions can be associated with each of the multiple user codes. This allows different users to have access to different vehicle functions. Each user code can have more access, less access, or different access to vehicle functions than other user codes. For example, where the vehicle is an ambulance and has a compartment containing pharmaceuticals, a person who is only a driver for the vehicle would not need access to the compartment and therefore would not be able to unlock the compartment door using their user code. The present invention contemplates any number of examples involving any number of different vehicles, especially specialized vehicles, and any number of types of users where there is reason to provide different users with different types of access to vehicle functions. In this manner, the present invention further provides for additional customization of features by providing flexibility based on the vehicle functions of the specific vehicle and the types of users who will have access to the vehicle functions.

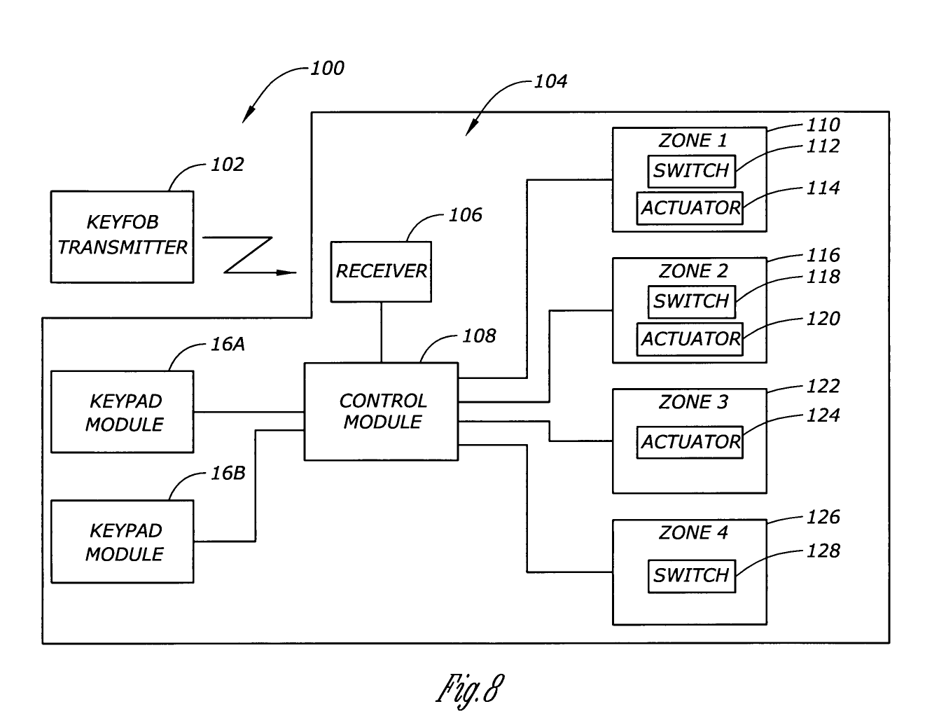

FIG. 9 illustrates another embodiment showing control of vehicle functions through more than one control module (38A, 38B). The vehicle functions that can be controlled include, but are not limited to those presented in the previous table. Examples include an actuator for a compartment door 60, an actuator for a lock 62, a unidirectional pulse 61 (such as for an engine compartment door), a toggle output 64 (such as for a porch light), a timed output 63 (such as for compartment lights), a sustained output 65, an output for a horn 66, a switch for a baggage light 68. Examples of sensors that can be used include, but are not limited to security system detectors 67, a sensor for entry door ajar 70, a sensor for compartment door ajar 72, an engine running sensor 74, and a key-in-ignition sensor 76. Of course, that which is specifically described is merely representative as the present invention contemplates numerous variations as may be appropriate in a particular vehicle configuration.

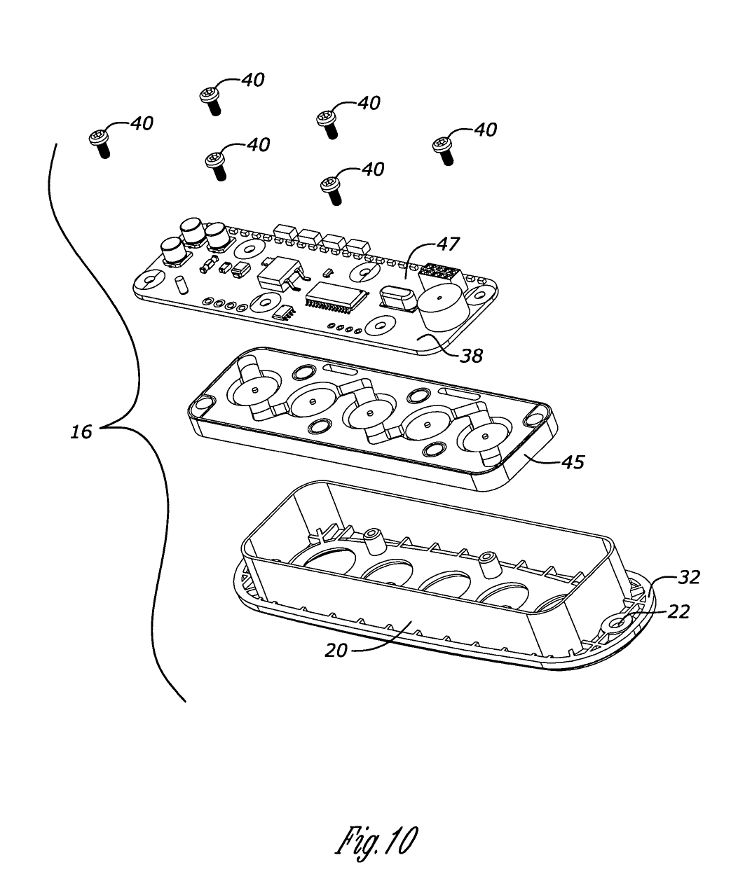

FIGS. 11, 12, and 13A-13F illustrate another embodiment of the present invention. In this embodiment, instead of using a keypad module with network messaging to a distributed controller module, a discrete keypad sends a high/low voltage signal to a centralized controller module. One advantage of this embodiment is easier integration withto existing vehicle electronics and realized cost savings.

In FIG. 11, a system 33 is shown with vehicle subsystem 35. Note that in FIG. 11 a discrete keypad 17 is shown instead of a keypad module. The discrete keypad 17 is electrically connected to an intelligent control 31 within the receiver 36. An optional controller module 37 may be electrically connected to the control module 31 to provide for control of additional functions when appropriate.

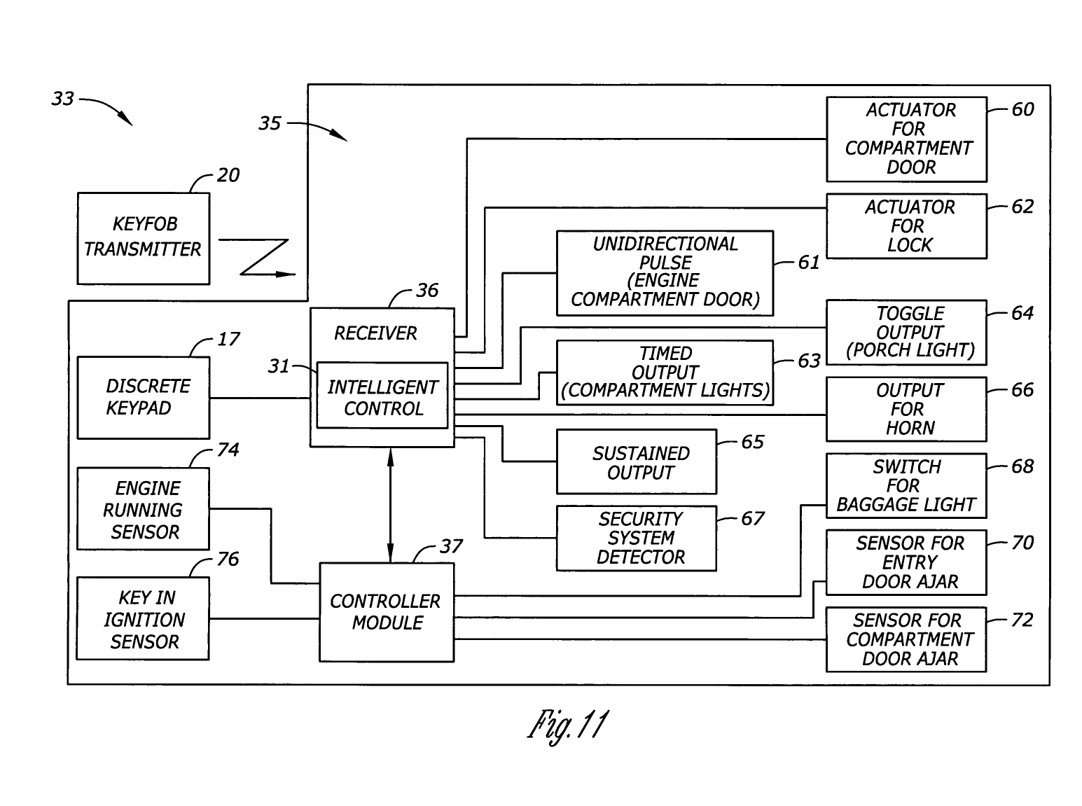

In FIG. 12, a system 101 is shown with vehicle subsystem 105. Within the vehicle subsystem 105, a discrete keypad 17 is electrically connected to an intelligent control 109 of the receiver 106. The receiver 106 and its intelligent control 109 are electrically connected to switches, actuators, sensors, and other devices to perform vehicle control functions. The discrete keypad 17 relies upon discrete signals (i.e. high/low voltage signals) as opposed to sending and receiving networked messages. Instead, the discrete keypad 17 is directly wired to the controller module 107.

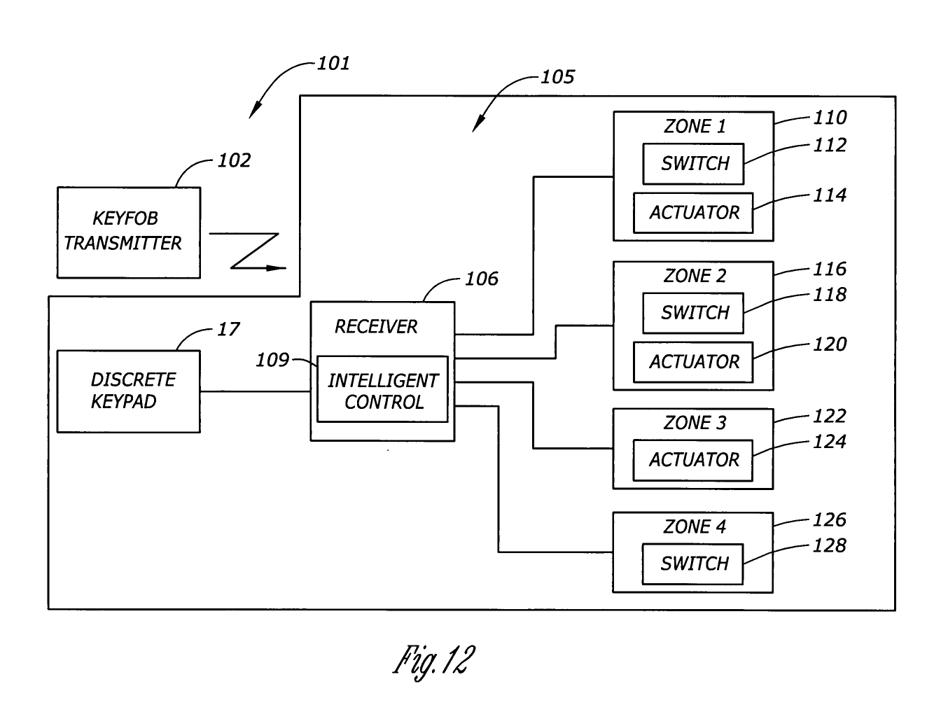

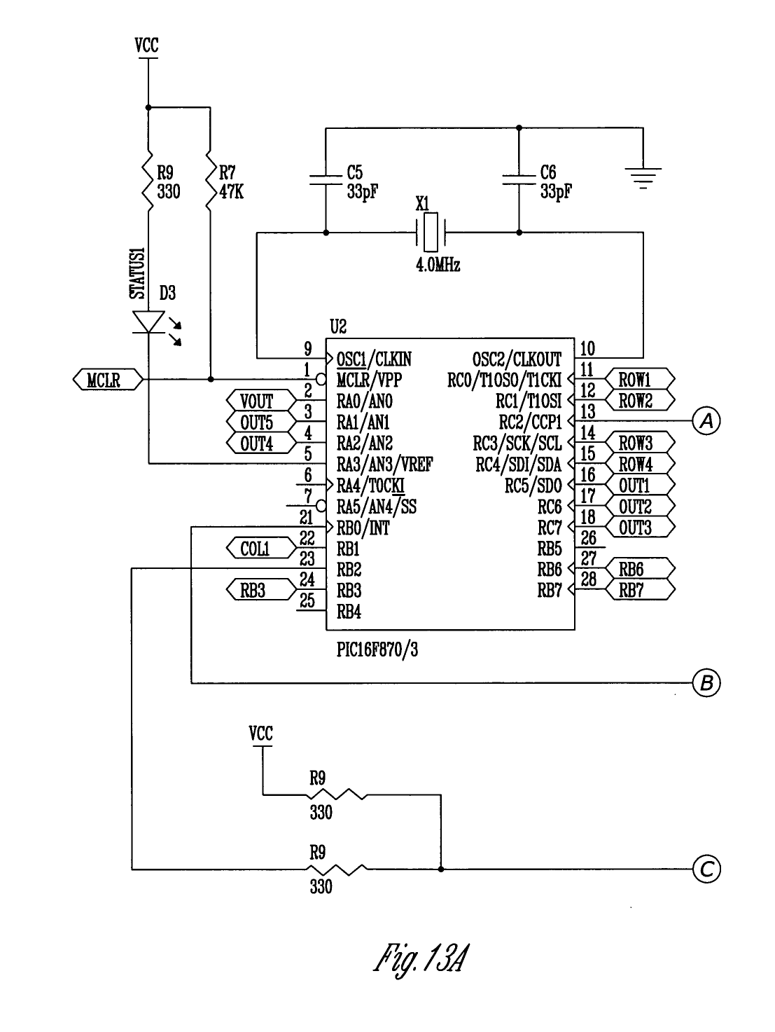

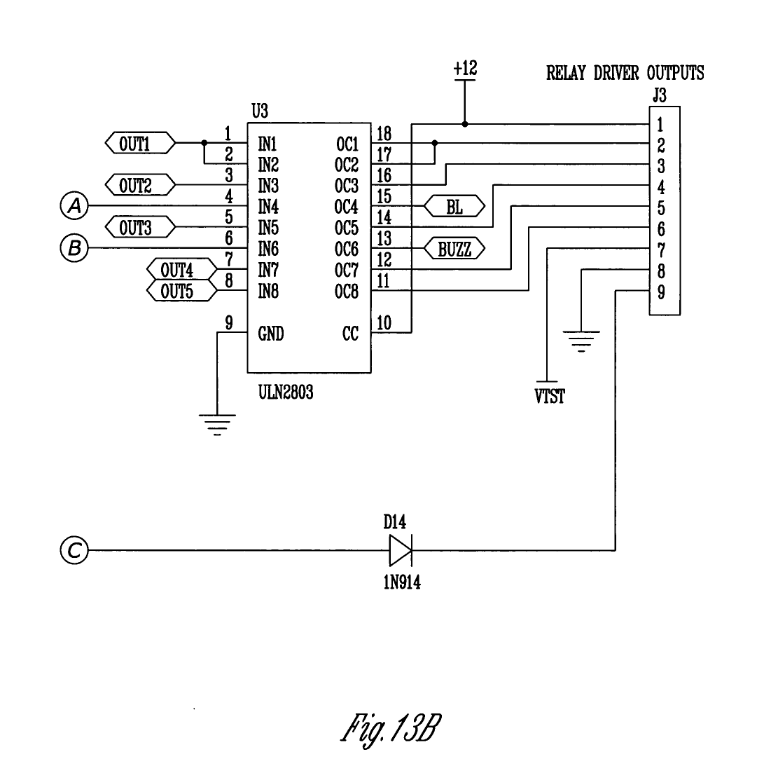

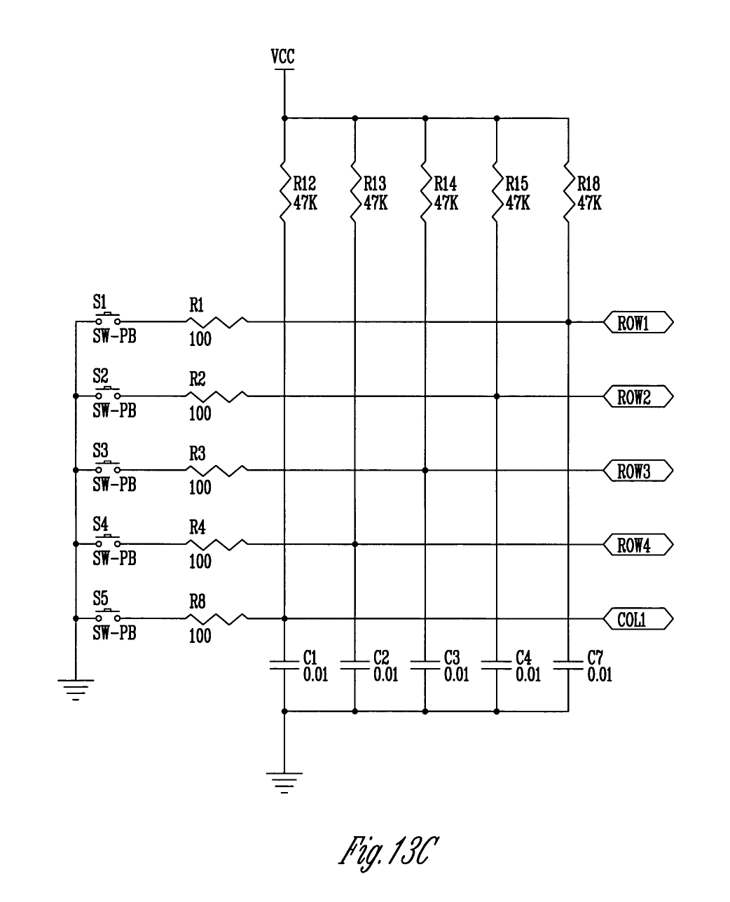

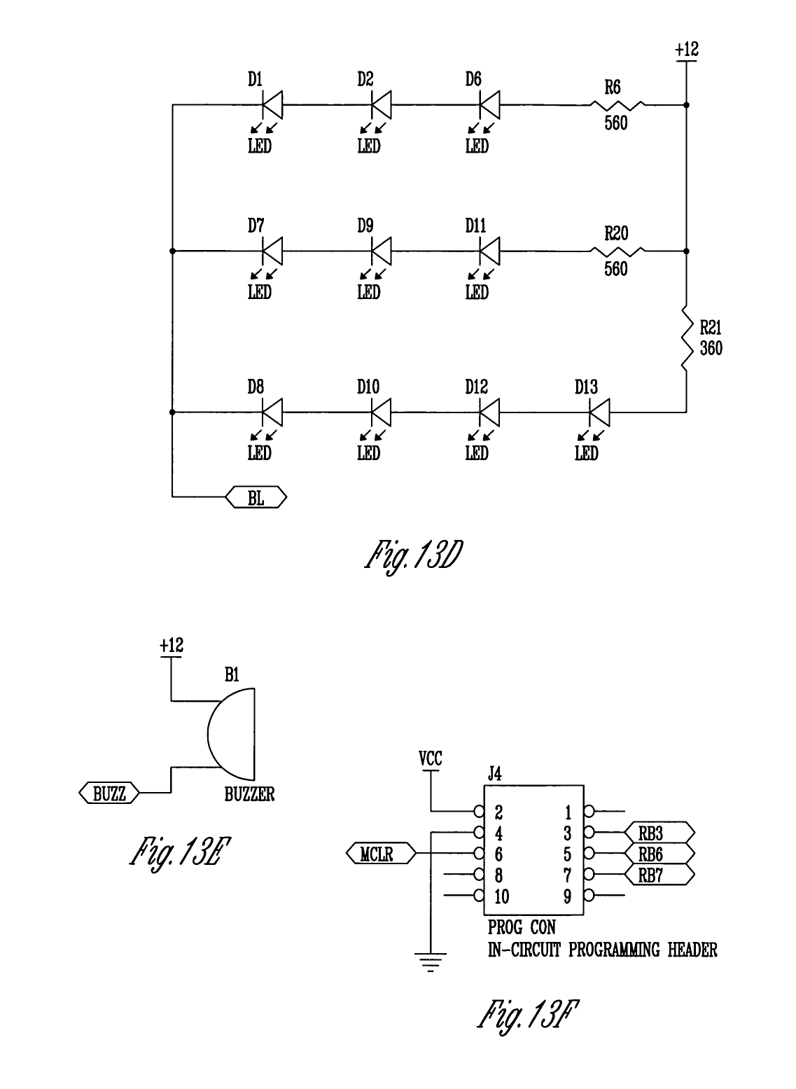

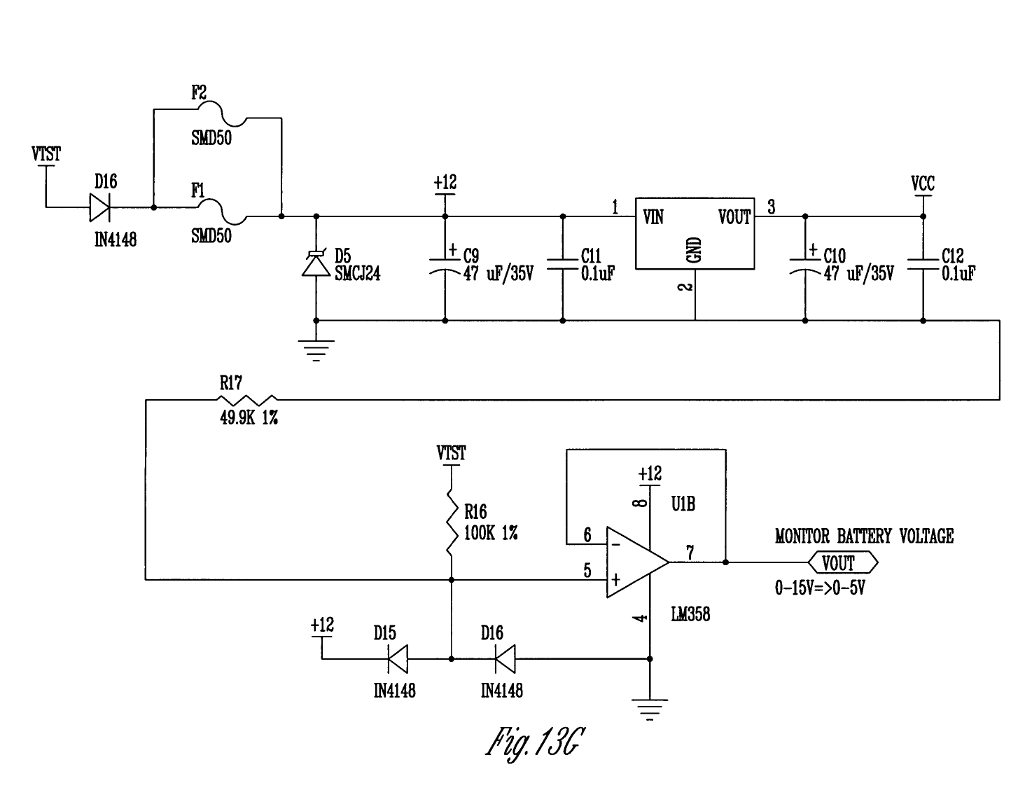

FIGS. 13A-13G provide an electrical schematic of a system having an intelligent control within the controller modules configured for use with a discrete keypad. The intelligent control can be a microcontroller such as a MicroChip PIC 16F870 as shown, or other type of microcontroller, processor, or other type of intelligent control. FIG. 13B is an electrical schematic showing relay drivers controlled by the intelligent control. The relay drivers can be used to control any number of vehicle functions, including an integral buzzer for providing audio feedback, actuators in various locations for various purposes, or other types of vehicle functions. FIG. 13C is an electrical schematic showing one embodiment of connections between the discrete keypad and the intelligent control. FIG. 13D is an electrical schematic showing the use of lighting devices such as LEDs to provide for visual feedback associated with the keypad. For example, each time one of the plurality of buttons on the keypad is pressed, a corresponding LED can flash to provide visual feedback that a keypress was received. Similarly, once a correct access code can be entered one or more LEDS can flash to indicate that a correct access code was received. FIG. 13E is an electrical schematic showing a buzzer electrically connected to the intelligent control to provide audio feedback. FIG. 13F is an electrical schematic to provide for in-circuit programming of the intelligent control. FIG. 13G is an electrical schematic illustrating the power supply for the control circuit and the circuitry for monitoring battery voltage. The present invention further contemplates that when the battery voltage is lower than expected (such as when a 12VDC supply drops below 11V) that appropriate feedback can be provided or power use can be reduced such as by turning off backlighting associated with the keypad.

Another embodiment of the present invention invention provides sufficient back lighting, yet using a lower power consumption. This is accomplished by usage of directional light emitting diodes (LEDs) and proper placement to provide a more effective illumination as compared to conventional LED usage. With more effective illumination, a lower PWM brightness setting can be used thus reducing parasitic current draw. In practice this method can result in as much as a 50% reduction in parasitic current draw.

The present invention contemplates numerous variations in the particular vehicle functions provided, variations in the communication between the keypad modules and other devices including control modules. In addition, the present invention contemplates variations in the number of keypads, the placement of keypads within a vehicle, the manner of fastening keypads to a vehicle, and the number of keys associated with a keypad. These and other variations are well within the spirit and scope of the invention.

1. A keypad for a vehicle entry system, comprising:
a housing having a front side, a back side, and side members, the front side having a flange adapted for mounting to a vehicle;
a plurality of buttons operatively connected to the housing and recessed in the front side, each of the plurality of buttons being press resistant to provide tactile feedback;
at least one lighting device associated with each of the plurality of buttons and operatively connected to the housing for providing visual feedback.

2. The keypad of claim 1 further comprising at least two apertures in the flange for accepting fasteners to mount to the vehicle.

3. The keypad of claim 1 wherein each of the plurality of buttons includes an identifier visibly exposed.

4. The keypad of claim 1 wherein each of the plurality of buttons are operatively connected to an intelligent control.

5. The keypad of claim 4 wherein the intelligent control is further adapted to control audio feedback to provide an audio alert for each press of the plurality of buttons.

6. The keypad of claim 5 wherein the audio alert comprises a chirp.

7. The keypad of claim 4 wherein the intelligent control is adapted to receive an access code from the plurality of buttons.

8. The keypad of claim 7 wherein the intelligent control is further adapted to verify the access code from the plurality of buttons and enable control of vehicle functions associated with the access code.

9. The keypad of claim 8 wherein the intelligent control is further adapted to control audio feedback such that if the access code is correct, the intelligent control initiates audio feedback.

10. The keypad of claim 9 wherein the audio feed back comprises a plurality of chirps.

11. The keypad of claim 8 wherein the intelligent control is further adapted receive a code for controlling one of the vehicle functions from the plurality of buttons wherein the code for controlling vehicle functions is associated with the access code.

12. The keypad of claim 6 wherein the vehicle code received from the plurality of buttons is a vehicle code for performing a vehicle function selected from the set consisting of sending a pulse, sending a plurality of pulses, activating an output, activating a plurality of staggered outputs, and sending a sustained output.

13. The keypad of claim 1 wherein the at least one lighting device includes a lighting device corresponding to each of the plurality of buttons.

14. The keypad of claim 1 wherein the at least one lighting device is adapted to flash each time one of the plurality of buttons is pressed.

15. The keypad of claim 4 wherein the intelligent control is disposed within the housing of the keypad.

16. The keypad of claim 1 wherein th at least one lighting device includes a plurality of directional light emitting diodes to provide effective illumination.

17. A method of using a keypad access and vehicle control system, comprising:
providing a keypad having (a) a housing having a front side, a back side, and side members, the front side having a flange adapted for mounting to a vehicle, (b) a plurality of buttons operatively connected to the housing and recessed in the front side, (c) at least one lighting device associated with each of the plurality of buttons and operatively connected to the housing for providing visual feedback;
receiving an access code from the plurality of buttons comprised of at least one keypress;
determining if the access code is correct and if so, receiving a code associated with at least one vehicle function, the code comprised of at least one keypress and enabled by the access code;
controlling the at least one vehicle function.

18. The method of claim 17 wherein the at least one vehicle function is selected from the set comprising a learn programming code, a change programming code, a lock all doors code, a change security code, an unlock zone code, an unlock all zones code, a toggle an auxiliary output code, a send a pulse output code, a send a change status code, a send a sustained output code, and a send a staggered output code.

19. The method of claim 17 further comprising illuminating at least one of the at least one lighting device in response to each of the least one keypress.

20. The method of claim 17 further comprising illuminating at least one of the at least one lighting device in response to the access code being correct.

21. The method of claim 17 further comprising producing an audible alert in response to the access code being correct.

22. The method of claim 17 wherein the vehicle is selected from a set consisting of a recreational vehicle, a truck, a specialty vehicle, an emergency vehicle, a construction vehicle, a bus, and an agricultural vehicle.
